(19) United States
(12) Patent Application Publication
(10) Pub. No.: US 2017/0371333 A1
(43) Pub. Date: Dec. 28, 2017

(54) SYSTEMS AND METHODS FOR CONTROLLING MULTIPLE AUTONOMOUS VEHICLES IN A CONNECTED DRIVE MODE

(71) Applicant: Robert Bosch GmbH, Stuttgart (DE)

(72) Inventors: Akos Nagy, Mountain View, CA (US); Shetty Rajaram, Bangalore (IN); Jeorg Vetter, Friesenheim (DE); Tatiana Mamaeva, Munchen (DE); Christian Kremer, Grossheubach (DE); Jan Becker, Palo Alto, CA (US)

(73) Assignee: Robert Bosch GmbH, Stuttgart (DE)

(21) Appl. No.: 15/540,892

(22) PCT Filed: Dec. 30, 2015
(86) PCT No.: PCT/US15/68071

§ 371 Date: Jun. 29, 2017

Related U.S. Application Data
(60) Provisional application No. 62/098,371, filed on Dec. 31, 2014.

(51) Int. Cl. G05D 1/00; G01C 21/34; G05D 1/02

(52) U.S. Cl. CPC G05D 1/0027; G05D 1/0291; G05D 1/0276; G01C 21/343; G05D 1/0016; G05D 1/0088

(57) ABSTRACT

Systems and methods for controlling multiple autonomous vehicles. One exemplary system includes a server including an electronic processor configured to receive, from a source device, a connected mode trip request including a first starting point, a destination, a first departure time, and a participant request. The electronic processor is further configured to receive a second starting point and to determine a first route including a destination arrival time. The electronic processor is further configured to determine a second route and a second departure time based on the second route and the destination arrival time. The electronic processor is further configured to send, to a recipient device, an invitation, including the second route and the second departure time. The electronic processor is further configured to receive, from the recipient device, a response to the invitation and send a notification based on the response to the source device.

### RELATED APPLICATIONS

This application claims the benefit of U.S. Provisional Application No. 62/098,371, filed Dec. 31, 2014, the entire content of which is incorporated herein by reference.

### FIELD

Embodiments of the present invention relate to the field of autonomous vehicles.

### BACKGROUND

Driver assistance systems have been successfully deployed to the market in the last fifteen years resulting in an increase of driving comfort and driving safety. As driver assistance systems progress in sophistication, less driver interaction is required. In some cases, the driver assistance systems may be fully automated for portions of a trip. Accordingly, the role of the driver has changed from that of an active driver to a passenger, for at least some duration of the trip. Highly automated vehicles will allow the driver to hand over control to the automated vehicle and to do other tasks while driving.

### SUMMARY

One exemplary embodiment provides a system for controlling multiple autonomous vehicles. The system includes a server that is communicatively coupled to a source device and a recipient device. The server includes an electronic processor configured to receive, from the source device, a connected mode trip request including a first starting point for a first autonomous vehicle, a destination, a first departure time, and a participant request. The electronic processor is further configured to receive a second starting point for a second autonomous vehicle based on the participant request. The electronic processor is further configured to determine a first route including a destination arrival time based on the first starting point, the destination, and the first departure time. The electronic processor is further configured to determine a second route based on the second starting point and the destination. The electronic processor is further configured to determine a second departure time based on the second route and the destination arrival time. The electronic processor is further configured to send, to the recipient device, an invitation, including the second route and the second departure time. The electronic processor is further configured to receive, from the recipient device, a response to the invitation and to send a notification based on the response to the source device.

Another embodiment provides a method for controlling multiple autonomous vehicles. The method includes receiving, from a source device, a connected mode trip request including a first starting point for a first autonomous vehicle, a destination, a first departure time, and a participant request and receiving a second starting point for a second autonomous vehicle based on the participant request. The method also includes determining, with an electronic processor, a first route including a destination arrival time, based on the first starting point, the destination, and the first departure time, determining, with the electronic processor, a second route based on the second starting point and the destination, and determining, with the electronic processor, a second departure time based on the second route and the destination arrival time. The method also includes sending, to a recipient device, an invitation, including the second route and the second departure time, receiving, from the recipient device, a response to the invitation, and sending, to the source device, a notification based on the response.

Other aspects of the invention will become apparent by consideration of the detailed description and accompanying drawings.

### BRIEF DESCRIPTION OF THE DRAWINGS

FIG. 1 illustrates a connected drive mode system in accordance with some embodiments.

FIG. 2 is a flowchart of an exemplary method for operating the connected mode drive system of FIG. 1 in accordance with some embodiments.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting, and coupling. Further, “connected” and “coupled” are not restricted to physical or mechanical connections or couplings, and can include electrical connections or couplings, whether direct or indirect. Also, electronic communications and notifications may be performed using any known means including wired connections, wireless connections, etc.

It should also be noted that a plurality of hardware and software based devices, as well as a plurality of different structural components may be utilized to implement the invention. It should also be noted that a plurality of hardware and software based devices, as well as a plurality of different structural components may be used to implement the invention. In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processors. As such, it should be noted that a plurality of hardware and software based devices, as well as a plurality of different structural components may be utilized to implement the invention. For example, “control units” and “controllers” described in the specification can include one or more processors, one or more memory modules including non-transitory computer-readable medium, one or more input/output interfaces, and various connections (e.g., a system bus) connecting the components.

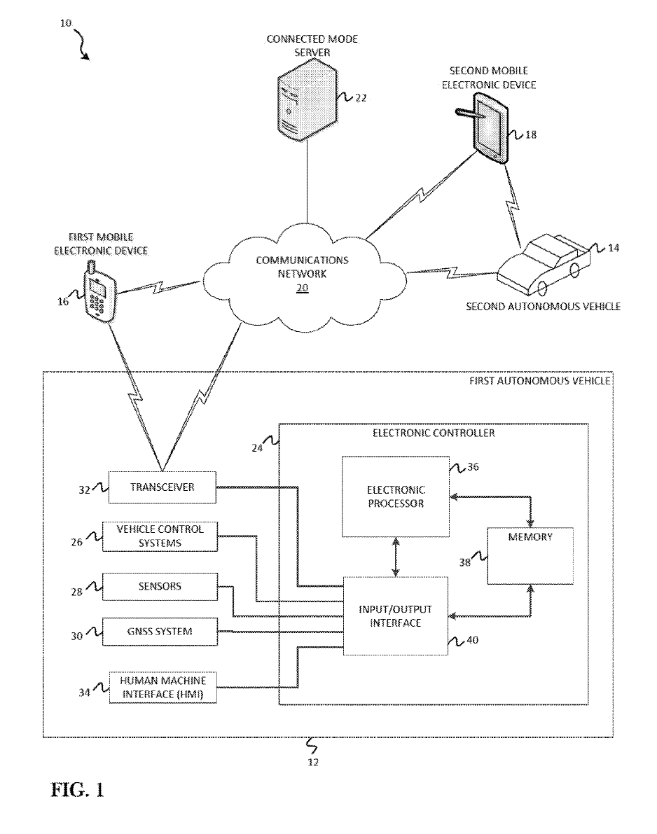

FIG. 1 is a block diagram of one exemplary embodiment of a connected drive mode system 10. The connected drive mode system 10 includes a first autonomous vehicle 12, a second autonomous vehicle 14, a first mobile electronic device 16, a second mobile electronic device 18, a communications network 20, and a connected mode server 22. For ease of description, the connected drive mode system 10 illustrated in FIG. 1 includes one of each of the foregoing components. Alternative embodiments may include one or more of each component, or may exclude or combine some components.

It should be noted that, in the description that follows, the terms “vehicle,” “autonomous vehicle,” and “automated vehicle” should not be considered limiting. The terms are used in a general way to refer to an autonomous or automated driving vehicle, which possesses varying degrees of automation (i.e., the vehicle is configured to drive itself with limited, or in some cases no, input from a driver). The systems and methods described herein may be used with any vehicle capable of operating partially or fully autonomously, being controlled manually by a driver, or some combination of both.

The term “driver,” as used herein, generally refers to an occupant of an autonomous vehicle who is seated in the driver's position, operates the controls of the vehicle while in a manual mode, or provides control input to the vehicle to influence the autonomous operation of the vehicle. The term “passenger,” as used herein, generally refers to an occupant of an autonomous vehicle who passively rides in the vehicle without controlling the driving operations of the vehicle. However, both the driver and passenger of an autonomous vehicle may share some of the other's role. For example, the driver may hand over the driving controls to the first autonomous vehicle 12 and ride in the vehicle as a passenger for some or all of a trip.

The term “trip,” as used herein, refers generally to the driving (manually or autonomously) of a vehicle from a starting point to a final destination point, with or without one or more waypoints in between. For example, a trip may start at a driver's home (i.e., the starting point), include a stop to pick up a passenger at the passenger's home (i.e., a waypoint), and continue to the workplace of the driver and the passenger (i.e., the destination). As described in greater detail below, a trip may also include more than one vehicle.

In the example illustrated, the first autonomous vehicle 12 includes an electronic controller 24, vehicle control systems 26, sensors 28, a global navigation satellite system (GNSS) 30, a transceiver 32, and a human machine interface (HMI) 34. The components of the first autonomous vehicle 12 (e.g., along with other various modules and components) are electrically coupled to each other by or through one or more control or data buses, which enable communication therebetween. The use of control and data buses for the interconnection between and communication among the various modules and components would be known to a person skilled in the art in view of the invention described herein. In alternative embodiments, some or all of the components of the first autonomous vehicle 12 may be communicatively coupled using suitable wireless modalities (for example, Bluetooth™ or near field communication). The electronic controller 24 controls the vehicle control systems 26, the sensors 28, the GNSS 30, the transceiver 32, and the human machine interface (HMI) 34 to autonomously control the first autonomous vehicle 12 according to the methods described herein. In some embodiments, the electronic controller 24 controls the vehicle control systems 26, the sensors 28, the GNSS 30, the transceiver 32, and the human machine interface (HMI) 34 by transmitting control signals or instructions to these devices and systems.

The electronic controller 24 includes an electronic processor 36 (e.g., a microprocessor, application specific integrated circuit, etc.), a memory 38, and an input/output interface 40. The memory 38 may include non-transitory computer-readable media and may include at least a program storage area and a data storage area. The program storage area and the data storage area can include combinations of different types of memory, such as read-only memory (“ROM”), random access memory (“RAM”) (e.g., dynamic RAM (“DRAM”), synchronous DRAM (“SDRAM”), etc.), electrically erasable programmable read-only memory (“EEPROM”), flash memory, a hard disk, an SD card, or other suitable magnetic, optical, physical, or electronic memory devices. The electronic processor 36 is coupled to the memory 38 and the input/output interface 40. The electronic processor 36 sends and receives information (e.g., from the memory 38 and/or the input/output interface 40) and processes the information by executing one or more software instructions or modules (e.g., stored in the memory 38 or another non-transitory computer readable medium). The software can include firmware, one or more applications, program data, filters, rules, one or more program modules, and other executable instructions. The electronic processor 36 is configured to retrieve from the memory 38 and execute, among other things, software to perform autonomous vehicle control and the methods as described herein.

The input/output interface 40 transmits and receives information from devices external to the electronic controller 24 (e.g., over one or more wired and/or wireless connections), such as the vehicle control systems 26, the sensors 28, the GNSS 30, the transceiver 32, and the HMI 34. The input/output interface 40 receives user input, provides system output, or a combination of both. As described herein, user input from a driver or passenger of a vehicle may be provided via, for example, the HMI 34. The input/output interface 40 may also include other input and output mechanisms that for brevity are not described herein but that may be implemented in hardware, software, or a combination of both.

It should be understood that although FIG. 1 illustrates only a single electronic processor 36, memory 38, and input/output interface 40, alternative embodiments of the electronic controller 24 may include multiple processing units, memory modules, and/or input/output interfaces. It should also be noted that the first autonomous vehicle 12 may include other electronic controllers each including similar components as and configured similarly to the electronic controller 24. In some embodiments, the electronic controller 24 is implemented partially or entirely on a semiconductor (e.g., a field-programmable gate array [“FPGA”] semiconductor) chip. Similarly, the various modules and controllers described herein may be implemented as individual controllers as illustrated or as components of a single controller. In some embodiments, a combination of approaches may be used.

The electronic processor 36 uses the input/output interface 40 to send and receive information or commands to and from the vehicle control systems 26 (e.g., over a vehicle communication bus, such as a CAN bus). The vehicle control systems 26 include components (e.g., actuators, motors, and controllers) to control a plurality of vehicle systems (e.g., braking, steering, and engine power output). For the sake of brevity, the vehicle control systems 26 will not be described in greater detail. The electronic processor 36 controls the vehicle control systems 26 to autonomously operate or drive the first autonomous vehicle 12. In some embodiments, the vehicle control systems 26 are controlled to automatically drive the first autonomous vehicle 12 without driver intervention or input for the entirety of a trip. In other embodiments, the vehicle control systems 26 are controlled to autonomously drive the first autonomous vehicle 12 for a portion of a trip and to allow or require a driver to manually operate the vehicle for one or more portions of the trip.

The sensors 28 are coupled to the electronic controller 24 and determine one or more attributes of the first autonomous vehicle 12. The sensors 28 communicate information regarding those attributes to the electronic controller 24 using, for example, electrical signals. The vehicle attributes include, for example, the position of the first autonomous vehicle 12 or portions or components of the first autonomous vehicle 12, the movement of the first autonomous vehicle 12 or portions or components of the first autonomous vehicle 12, the forces acting on the first autonomous vehicle 12 or portions or components of the first autonomous vehicle 12, and the proximity of the first autonomous vehicle 12 to other vehicles or objects (stationary or moving). The sensors 28 may include, for example, vehicle control sensors (e.g., sensors that detect accelerator pedal position, brake pedal position, and steering wheel position [steering angle]), wheel speed sensors, vehicle speed sensors, yaw sensors, force sensors, odometry sensors, and vehicle proximity sensors (e.g., camera, radar, ultrasonic). The electronic controller 24 receives and interprets the signals received from the sensors 28 to determine values for one or more vehicle attributes, including, for example, vehicle speed, steering angle, vehicle position, pitch, yaw, and roll. The electronic controller 24 controls the vehicle control systems 26 to autonomously control the first autonomous vehicle 12 (for example, by generating braking signals, acceleration signals, steering signals) based at least in part on the information received from the sensors 28. Some of the sensors 28 may be integrated into the vehicle control systems 26, while others may be deployed on the vehicle separately from the vehicle control systems 26.

The GNSS 30 receives radiofrequency signals from orbiting satellites using one or more antennas and receivers (not shown). The GNSS 30 determines geo-spatial positioning (i.e., latitude, longitude, altitude, and speed) for the vehicle based on the received radiofrequency signals. The GNSS 30 communicates this positioning information to the electronic controller 24. The electronic controller 24 may use this information in conjunction with or in place of information received from the sensors 28 when controlling the first autonomous vehicle 12. The electronic controller 24 controls the GNSS 30 to plan routes and navigate the first autonomous vehicle 12. GNSS systems are known, and will not be described in greater detail. In some embodiments, the GNSS 30 may operate using the GPS (global positioning system). Alternative embodiments may use a regional satellite navigation system, and/or a land-based navigation system in conjunction with, or in place of, the GNSS 30.

The transceiver 32 includes a radio transceiver communicating data over one or more wireless communications networks (e.g., cellular networks and land mobile radio networks) including the communications network 20. The transceiver 32 also provides wireless communications within the vehicle using suitable network modalities (e.g., Bluetooth™, near field communication (NFC), Wi-Fi™, and the like). Accordingly, the transceiver 32 communicatively couples the electronic controller 24 and other components of the first autonomous vehicle 12 with networks or electronic devices both inside and outside the first autonomous vehicle 12. The transceiver 32 includes other components that enable wireless communication (e.g., amplifiers, antennas, baseband processors, and the like), which for brevity are not described herein and which may be implemented in hardware, software, or a combination of both. Some embodiments include multiple transceivers or separate transmitting and receiving components (e.g., a transmitter and a receiver) instead of a combined transceiver.

The human machine interface (HMI) 34 provides an interface between the first autonomous vehicle 12 and the driver and/or the passenger. The HMI 34 is electrically coupled to the electronic controller 24 and receives input from the driver, receives information from the electronic controller 24, and provides feedback (e.g., audio, visual, haptic, or a combination thereof) to the driver based on the received information. The HMI 34 provides suitable input mechanisms, such as a button, a touch-screen display having menu options, voice recognition, etc., for receiving inputs from the driver that may be used by the electronic controller 24 to control the first autonomous vehicle 12.

The HMI 34 provides visual output, such as, for example, graphical indicators (i.e., fixed or animated icons), lights, colors, text, images, combinations of the foregoing, and the like. The HMI 34 includes a suitable display mechanism for displaying the visual output, such as, for example, an instrument cluster, a mirror, a heads-up display, a center console display screen (for example, a liquid crystal display (LCD) touch screen, or an organic light-emitting diode (OLED) touch screen), or other suitable mechanisms. In alterative embodiments, the display screen may not be a touch screen. In some embodiments, the HMI 34 displays a graphical user interface (GUI) (for example, generated by the electronic processor 36, from instructions and data stored in the memory 38, and presented on the display screen) that enables a user to interact with the first autonomous vehicle 12. The HMI 34 may also provide audio output to the driver such as a chime, buzzer, voice output, or other suitable sound through a speaker included in the HMI 34 or separate from the HMI 34. In some embodiments, HMI 34 provides haptic outputs to the driver by vibrating one or more vehicle components (e.g., the vehicle's steering wheel and the driver's seat), such as through the use of a vibration motor. In some embodiments, HMI 34 provides a combination of visual, audio, and haptic outputs.

The second autonomous vehicle 14 contains similar components as and operates similarly to the first autonomous vehicle 12.

The first mobile electronic device 16 is communicatively coupled to the communications network 20 and the transceiver 32 and wirelessly communicates with the connected mode server 22, the electronic controller 24, and other components of first autonomous vehicle 12 using suitable network modalities. In alternative embodiments, the first mobile electronic device 16, when near to or inside the first autonomous vehicle, may be communicatively coupled to the electronic controller 24 via a wired connection using, for example, a universal serial bus (USB) connection or similar connection. In the illustrated embodiment, the first mobile electronic device 16 is a smart telephone. In alternative embodiments, the first mobile electronic device 16 may be, for example, a tablet computer, personal digital assistant (PDA), a smart watch, or any other portable or wearable electronic device that includes or can be connected to a network modem or similar components that enable wireless or wired communications (e.g., a processor, memory, i/o interface, transceiver, antenna, and the like). In some embodiments, the HMI 34 communicates with the first mobile electronic device 16 to provide the visual, audio, and haptic outputs described above through the first mobile electronic device 16 when the first mobile electronic device 16 is communicatively coupled to the first autonomous vehicle 12.

The second mobile electronic device 18 contains similar components as and operates similarly to the first mobile electronic device 16. The second mobile electronic device 18 is communicatively coupled to the communications network 20 and the second autonomous vehicle 14, and wirelessly communicates with the connected mode server 22, and components of second autonomous vehicle 14 using suitable network modalities. In the illustrated embodiment, the second mobile electronic device 18 is a tablet computer. In alternative embodiments, the second mobile electronic device 18 may be another type of mobile electronic device capable of communicatively coupling as described above with respect to the first mobile electronic device 16.

The communications network 20 may include one or more cellular networks (e.g., long term evolution (LTE), Time Division Multiple Access (TDMA), and Code Division Multiple Access (CDMA)), land-mobile radio networks, and other local and wide area data networks (e.g., Worldwide Interoperability for Microwave Access (WiMax)). Portions of the communications network 20 may switch or route network traffic, including voice telephone calls (e.g., cellular and landline calls), digital and analog radio communications, voice over internet protocol (VoIP), short message service (SMS) messages and multimedia message service (MMS) messages (“text messages”), transmission control protocol/internet protocol (TCP/IP) data traffic, and the like through one or more connections to a public switched telephone network (PSTN), the Internet, or both.

The connected mode server 22 is communicatively coupled to the communications network 20. The connected mode server 22 includes, among other things, an electronic processor (e.g., a microprocessor or another suitable programmable device), a memory (i.e., a computer-readable storage medium), and an input/output interface (not shown). The electronic processor, the memory, and the input/output interface, as well as the other various modules are connected by one or more control or data buses, the use of which would be known to a person skilled in the art in view of the invention described herein. The memory of the connected mode server 22 stores software (e.g., firmware, one or more applications, program data, filters, rules, one or more program modules, and/or other executable instructions), which includes instructions for operating the connected mode server 22 as described herein.

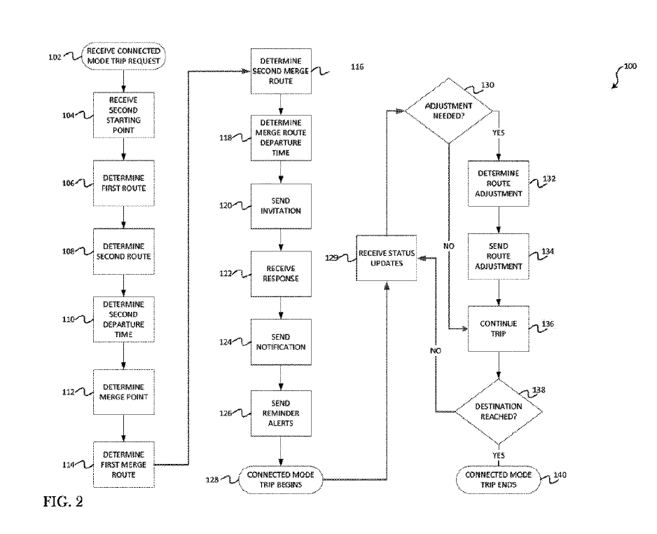

FIG. 2 illustrates an exemplary method 100 for operating the connected drive mode system 10. As an example, the method 100 is described in terms of a driver of the first autonomous vehicle 12 requesting a connected mode trip that includes the first autonomous vehicle 12 and the second autonomous vehicle 14 beginning at separate starting points and arriving at a common destination at or about the same time. In the example described, the first autonomous vehicle 12 and the second autonomous vehicle 14 meet at a merge point (i.e., a point common to both routes) at or about the same time and proceed together to the destination. This should not be considered limiting; the concepts embodied in the example described may be applied to more than two autonomous vehicles or to trips of different types. Embodiments of the method 100 use automated routing mechanisms to plan trips (e.g., “turn-by-turn” directions and the like for vehicles travelling public or private roadways) between starting points and destinations. Automated routing is known, and will not be described in greater detail herein.

Portions of the method 100 are described below in terms of a source device and a recipient device. However, this should not be considered limiting. The terms “source” and “recipient” are to be viewed in relation to the planning of a trip. Generally, the source device sends data requesting a trip (e.g., as described below, a connected mode trip request) to the connected mode server 22, and the recipient device receives data regarding the requested trip (e.g., as described below, an invitation to join a connected mode trip) from the connected mode server 22. However, in some embodiments, the source and recipient devices both send and receive data.

In some embodiments, the source device is the electronic controller 24 of the first autonomous vehicle 12. For example, a driver of the first autonomous vehicle 12 may enter data via the HMI 34 and send the data to the connected mode server 22 via the electronic controller 24 and the transceiver 32. In another embodiment, the source device is the first mobile electronic device 16, communicating either directly with the connected mode server 22 via the communications network 20 or indirectly through the first autonomous vehicle 12 while the first mobile electronic device 16 is communicatively coupled to the first autonomous vehicle 12. Likewise, in some embodiments, the recipient device is an electronic controller of the second autonomous vehicle 14 (e.g., presented on a human machine interface), and, in other embodiments, the recipient device is the second mobile electronic device 18. In some embodiments, the source and recipient devices may be another electronic device communicatively coupled to the communications network 20 (e.g., via the Internet), such as a personal computer. In some embodiments, the nature of the source and recipient devices may change over time (e.g., a mobile electronic device may hand off to an electronic controller of an autonomous vehicle, and vice-versa).

At block 102, the connected mode server 22 receives a connected mode trip request for the first autonomous vehicle 12 from a source device. The connected mode trip request includes a first starting point for a first autonomous vehicle 12, a destination for the trip (e.g., a park, restaurant, residence, place of business, or other point of interest), a first departure time (i.e., the time that the first autonomous vehicle 12 begins the trip), and a participant request (i.e., a request that the second autonomous vehicle 14 participate in the connected mode trip). For example, a driver of the first autonomous vehicle 12 may plan on departing the driver's home at three o'clock to travel to a museum and may wish to have their friend, the driver of the second autonomous vehicle 14, meet them at the museum at the same time. Accordingly, the driver of the first autonomous vehicle 12 enters a connected mode trip request including the driver's home, three o'clock, and an identifier for their friend or the friend's vehicle into a source device.

At block 104, the connected mode server 22 receives a second starting point for the requested participant (i.e., the location from which the second autonomous vehicle 14 will begin the trip). The second starting point may be received from the second autonomous vehicle 14 (e.g., in response to a query from the connected mode server 22) or as part of the connected mode trip request if the requestor knows (or wants to suggest) a starting point for the second autonomous vehicle. For example, the driver of the first autonomous vehicle, in planning his trip to the museum, may know that his or her friend will leave from the friend's workplace, and enter the address of the friend's workplace as the second starting point. In another example, the second autonomous vehicle 14 may report its location to the connected mode server 22, which the connected mode server 22 can use as the second starting point.

At block 106, the connected mode server 22 determines a first route (i.e., for the first autonomous vehicle 12), based on the first starting point, the destination, and the departure time. The connected mode server 22 then determines at what time the first autonomous vehicle 12 should arrive at the destination (i.e., the destination arrival time) if the first autonomous vehicle 12 begins the first route at the departure time and proceeds at posted speeds under normally-expected traffic conditions. The connected mode server 22 may access map data and, optionally, current traffic data stored internally or on a separate device to determine the route and the associated destination arrival time.

Using the second starting point and the destination, the connected mode server 22 also determines a second route for the second autonomous vehicle 14, at block 108. Using the destination arrival time associated with the first route and the second route, the connected mode server 22 determines at what time the second autonomous vehicle 14 should begin its route (the second departure time) to arrive at the destination at or about the destination arrival time associated with the first route. As with the destination arrival time, the determination of the second departure time assumes that the second autonomous vehicle 14 will travel at posted speeds under normally-expected traffic conditions.

At block 112, the connected mode server 22 determines a merge point based on the first and second routes. A merge point is a point at which two or more vehicles, each following its own individual route, meet up to take one route. For example, two or more different routes ending in a common destination may share portions with each other, particularly as the routes converge on the common destination. Determining a merge point may be desirable for longer trips, where multiple drivers wish to convoy or caravan so that stops along the merged portion of the trip may be more easily coordinated. In some embodiments, the connected mode server 22 determines a merge point that allows the routes to converge and share as much of the trip as possible. It should be understood that in other embodiments, the connected mode server 22 may not determine a merge point. The request initially received by the connected mode server 22 may also specify whether a merge point is desired (and, optionally, other parameters for the merge point, such as whether the merge point should be made as soon as possible or within a predetermined distance of the final destination).

Ensuring that multiple vehicles meet at a merge point at or about the same time may require adjusting the routes of one or more of the vehicles (e.g., by changing the roadways travelled or the speed at which the vehicles travel for one or more portions of the trip). According, in some embodiments of the method 100, the connected mode server 22 determines a first merge route for the first autonomous vehicle 12, at block 114. The first merge route is based on the first route and the merge point, and includes a merge point arrival time (i.e., when the first autonomous vehicle 12 will arrive at the merge point), and a merge destination arrival time (i.e., the arrival time as determined at block 106, adjusted based on the differences between the first route and the first merge route). At block 116, the connected mode server 22 determines a second merge route for the second autonomous vehicle 14. The second merge route is based on the second route and the merge point. At block 118, the connected mode server 22 determines a merge route departure time for the second autonomous vehicle 14 based on the second merge route, the merge point arrival time, and the merge destination arrival time. The merge route departure time is the time at when the second autonomous vehicle 14 should begin its route, taking into account the adjustments made to the second route based on the addition of the merge point.

At block 120, the connected mode server 22 sends an invitation to a recipient device. The invitation includes the second route, the departure time, the second merge route, and the merge route departure time. The recipient device presents the invitation and the routes (e.g., using a graphical user interface) and prompts the driver of the second autonomous vehicle 14 to accept or reject the invitation and choose a route. As noted above, in some embodiments, a merge point is not determined. In such embodiments, the method 100 proceeds from block 110 to block 120, omitting blocks 112 through 118.

At block 122, the connected mode server 22 receives a response from the invitation based on the acceptance of rejection of the invitation and the route choice. The connected mode server 22 sends a notification to the source device, based on the response, at block 124. In some embodiments, in addition to or as an alternative to sending the notification to the source device, the connected mode server 22 may send a notification to device different than the source device (i.e., a device different from the device making the initial request).

When the driver of the second autonomous vehicle 14 accepts the invitation, the connected mode server 22 sends reminder alerts, at block 126. A first reminder alert, based on the first departure time is sent to the source device. A second reminder alert, based on the second departure time (or the merge route departure time, if applicable) is sent to the recipient device. The reminder alerts include information that a connected mode trip is scheduled to begin and the scheduled departure time. In some embodiments, the connected mode server 22 sends multiple alerts (e.g., at five minute increments beginning thirty minutes from the respective departure time).

At block 128, the connected mode trip begins with the first autonomous vehicle 12 beginning its route at the departure time, and the second autonomous vehicle beginning its route at the second departure time (or the merge route departure time, if applicable). In some embodiments of the method 100, at block 129, the connected mode server 22 may receive one or more status updates from, for example, the first autonomous vehicle 12, the second autonomous vehicle 14, the first mobile electronic device 16, the second mobile electronic device 18, or an external service (e.g., a traffic reporting service) through the communications network 20 via, for example, the Internet. The status updates may include updates on the current speed and location of the first autonomous vehicle 12 and the second autonomous vehicle 14 or updates to the traffic congestion levels along portions of the routes.

At block 130, the connected mode server 22 determines whether an adjustment (i.e., to one or both routes) is needed based on the one or more status updates received. For example, if traffic conditions have worsened or one of the vehicles has been travelling above or below posted speeds, then one or both routes may have to be adjusted so that both the first autonomous vehicle 12 and the second autonomous vehicle 14 can still arrive at the destination at or near the arrival time. Accordingly, when one or more route adjustments are necessary, the connected mode server 22 determines the route adjustment(s) at block 132. For example, if the first autonomous vehicle 12 has been travelling more slowly than expected, the connected mode server 22 may determine that the second autonomous vehicle 14 should begin travelling more slowly for some portion of its route to make up for the change. At block 134, this route adjustment is sent to the source device, the recipient device, or both, depending on which route or routes are to be adjusted.

At block 136, the first autonomous vehicle 12 and the second autonomous vehicle 14 continue their respective routes of the connected mode trip. At block 138, if the destination is reached, the connected mode trip ends at block 140. If the destination has not been reached, the connected mode server 22 continues to check for status updates and act on them as needed, at blocks 129 through 136.

Thus, the invention provides, among other things, systems and methods for controlling multiple autonomous vehicles in a connected drive mode. Various features and advantages of the invention are set forth in the following claims.

What is claimed is:

1. A system for controlling multiple autonomous vehicles, the system comprising:
a server, communicatively coupled to a source device and a recipient device, the server including an electronic processor configured to
receive, from the source device, a connected mode trip request including a first starting point for a first autonomous vehicle, a destination, a first departure time, and a participant request;
receive a second starting point for a second autonomous vehicle based on the participant request;
determine a first route including a destination arrival time based on the first starting point, the destination, and the first departure time;
determine a second route based on the second starting point and the destination;
determine a second departure time based on the second route and the destination arrival time;
send, to the recipient device, an invitation, including the second route and the second departure time;
receive, from the recipient device, a response to the invitation; and
send a notification based on the response to the source device.

2. The system of claim 1, wherein the source device is one selected from a group consisting of the first autonomous vehicle and a first mobile electronic device.

3. The system of claim 1, wherein the recipient device is one selected from a group consisting of the second autonomous vehicle and a second mobile electronic device.

4. The system of claim 1, wherein the electronic processor is further configured to
send, to the source device, a first reminder alert based on the first departure time; and
send, to the recipient device, a second reminder alert based on the second departure time.

5. The system of claim 1, wherein the electronic processor is further configured to receive at least one status update;
determine at least one route adjustment based on the at least status update; and
send the at least one route adjustment to at least one a group consisting of the source device and the recipient device.

6. The system of claim 5, wherein the at least one status update is received from at least one of a group consisting of the first autonomous vehicle, the second autonomous vehicle, a first mobile electronic device, a second mobile electronic device, and an external service.

7. The system of claim 1, wherein the electronic processor is further configured to
determine a merge point based on the first route and the second route;
determine a first merge route, including a merge point arrival time and a merge destination arrival time, based on the first route and the merge point;
determine a second merge route based on the second route and the merge point; and
determine a merge route departure time based on the second merge route, the merge point arrival time, and the merge destination arrival time;
wherein the invitation further includes the second merge route and the merge route departure time.

8. A method for controlling multiple autonomous vehicles, the method comprising:
receiving, from a source device, a connected mode trip request including a first starting point for a first autonomous vehicle, a destination, a first departure time, and a participant request;
receiving a second starting point for a second autonomous vehicle based on the participant request;
determining, with an electronic processor, a first route including a destination arrival time, based on the first starting point, the destination, and the first departure time;
determining, with the electronic processor, a second route based on the second starting point and the destination;
determining, with the electronic processor, a second departure time based on the second route and the destination arrival time;
sending, to a recipient device, an invitation, including the second route and the second departure time;
receiving, from the recipient device, a response to the invitation; and
sending, to the source device, a notification based on the response.

9. The method of claim 8, wherein receiving the connected mode trip request includes receiving the connected mode trip request from one selected from a group consisting of the first autonomous vehicle and a first mobile electronic device.

10. The method of claim 8, wherein sending the invitation includes sending the invitation to one selected from a group consisting of the second autonomous vehicle and a second mobile electronic device.

11. The method of claim 8, further comprising:
sending, to the source device, a first reminder alert based on the first departure time; and
sending, to the recipient device, a second reminder alert based on the second departure time.

12. The method of claim 8, further comprising:
receiving, with the electronic processor, at least one status update;
determining, with the electronic processor, at least one route adjustment based on the at least status update; and
sending, with the electronic processor, the at least one route adjustment to at least one a group consisting of the source device and the recipient device.

13. The method of claim 12, wherein receiving the at least one status update includes receiving the at least one status update from at least one of a group consisting of the first autonomous vehicle, the second autonomous vehicle, a first mobile electronic device, a second mobile electronic device, and an external service.

14. The method of claim 8, further comprising:
determining, with the electronic processor, a merge point based on the first route and the second route;
determining, with the electronic processor, a first merge route, including a merge point arrival time and a merge destination arrival time, based on the first route and the merge point;
determining, with the electronic processor, a second merge route based on the second route and the merge point; and
determining, with the electronic processor, a merge route departure time based on the second merge route, the merge point arrival time, and the merge destination arrival time;
wherein sending the invitation includes sending the second merge route and the merge route departure time.
